(19) United States
(12) Patent Application Publication
(10) Pub. No.: US 2017/0032319 A1
(43) Pub. Date: Feb. 2, 2017

(54) UNDO FEATURE IN FINANCIAL MANAGEMENT SOFTWARE

(71) Applicants: Amarendra Srivastava, Bangalore (IN); Saurabh Saxena, Bangalore (IN); Mohan Sunkara, Bangalore (IN)

(72) Inventors: Amarendra Srivastava, Bangalore (IN); Saurabh Saxena, Bangalore (IN); Mohan Sunkara, Bangalore (IN)

(73) Assignee: Intuit Inc., Mountain View, CA (US)

(21) Appl. No.: 14/814,652

(22) Filed: Jul. 31, 2015

(51) Int. Cl. G06Q 10/10

(52) U.S. Cl. CPC G06Q 10/10

(57) ABSTRACT

A method for managing a plurality of financial documents using a financial management application (FMA). The method includes performing a plurality of activities of the FMA, recording, in an activity feed, the plurality of activities and metadata describing characteristics of performing the plurality of activities, selecting, in response to a user request to undo a first activity of the plurality of activities, the first activity from the activity feed, selecting, based on the metadata and from the plurality of financial documents, a first financial document that was accessed by the FMA when performing the first activity, identifying, based on the metadata, a first result of the first activity on the first financial document, and modifying the first financial document to remove the first result of the first activity.

### BACKGROUND

A user of an accounting software generates a large volume of financial documents, such as invoices, customer files, checks, etc. during day-to-day activities. From time to time, a user may alter or delete a financial document by mistake. By the time the user realize the mistake, the altered or deleted financial document may not be recoverable.

### SUMMARY

In general, in one aspect, the invention relates to a method for managing a plurality of financial documents using a financial management application (FMA). The method includes performing a plurality of activities of the FMA, recording, in an activity feed, the plurality of activities and metadata describing characteristics of performing the plurality of activities, selecting, in response to a user request to undo a first activity of the plurality of activities, the first activity from the activity feed, selecting, based on the metadata and from the plurality of financial documents, a first financial document that was accessed by the FMA when performing the first activity, identifying, based on the metadata, a first result of the first activity on the first financial document, and modifying the first financial document to remove the first result of the first activity.

In general, in one aspect, the invention relates to a system that includes a computer processor, memory storing instructions of a financial management application (FMA) that are executable by the computer processor for managing a plurality of financial documents, and a repository. The instructions includes an activity engine configured to perform a plurality of activities of the FMA, and an undo engine configured to record, in an activity feed, the plurality of activities and metadata describing characteristics of performing the plurality of activities, select, in response to a user request to undo a first activity of the plurality of activities, the first activity from the activity feed, select, based on the metadata and from the plurality of financial documents, a first financial document that was accessed by the FMA when performing the first activity, identify, based on the metadata, a first result of the first activity on the first financial document, and modify the first financial document to remove the first result of the first activity. The repository is configured to store the activity feed and the first financial document.

In general, in one aspect, the invention relates to a non-transitory computer readable medium storing instructions for managing a plurality of financial documents using a financial management application (FMA). The instructions, when executed by a computer processor, comprising functionality for performing a plurality of activities of the FMA, recording, in an activity feed, the plurality of activities and metadata describing characteristics of performing the plurality of activities, selecting, in response to a user request to undo a first activity of the plurality of activities, the first activity from the activity feed, selecting, based on the metadata and from the plurality of financial documents, a first financial document that was accessed by the FMA when performing the first activity, identifying, based on the metadata, a first result of the first activity on the first financial document, and modifying the first financial document to remove the first result of the first activity.

Other aspects of the invention will be apparent from the following transaction description and the appended claims.

### BRIEF DESCRIPTION OF DRAWINGS

FIG. 1 shows a block diagram of a system in accordance with one or more embodiments of the invention.

FIG. 2 shows a flowchart in accordance with one or more embodiments of the invention.

FIGS. 3A and 3B show an example in accordance with one or more embodiments of the invention.

FIG. 4 shows a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency. Further, in the figures, three collinear dots mean that more elements of the same type as before the three collinear dots may optionally exist in accordance with one or more embodiments of the invention.

In the following detailed transaction description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the transaction description.

In general, embodiments of the invention provide a method, system, and computer readable medium for logging user activities in an activity feed of a financial management application so that an activity may be later selected by the user to be undone.

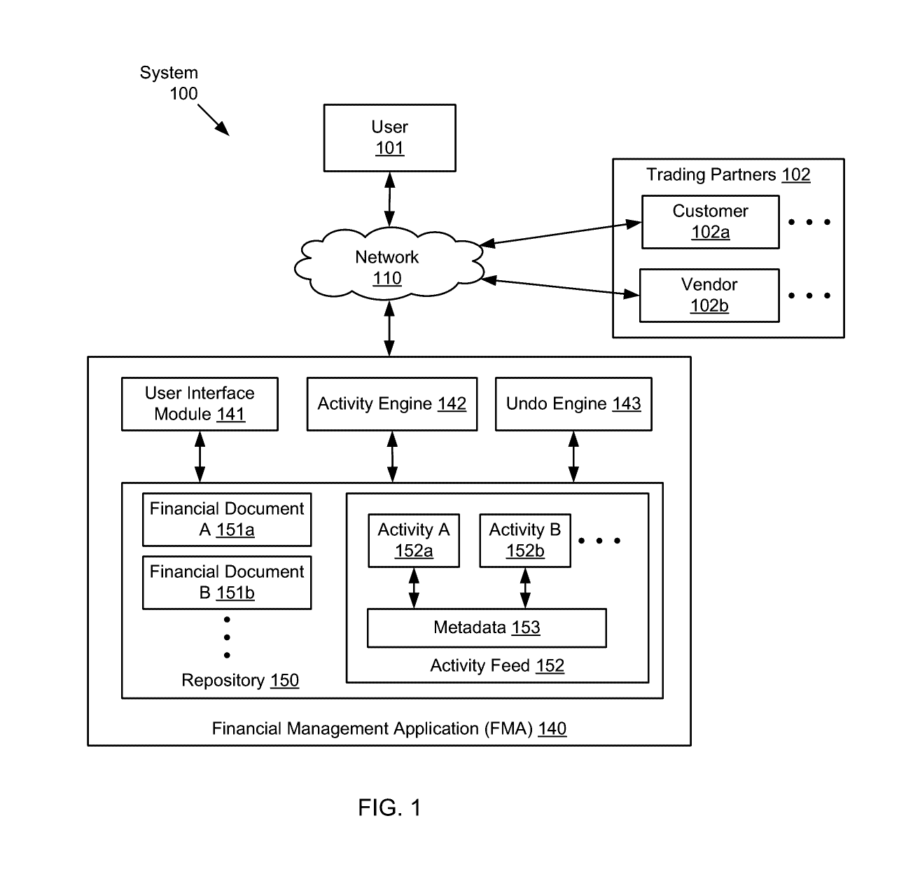

FIG. 1 shows a block diagram of a system (100) in accordance with one or more embodiments of the invention. Specifically, the system (100) includes a user (101), trading partners (102) (e.g., customer (102a), vendor (102b)) of the user (101), a financial management application (FMA) (140) used by the user (101) that are coupled via a network (110). The FMA (140) includes a user interface module (141), an activity engine (142), an undo engine (143), and a repository (150) which stores data used and/or generated by the user interface module (141), the activity engine (142), and the undo engine (143). In one or more embodiments of the invention, the network (110) may include a cellular phone network, a wide area network, a local area network, a public switched telephone network (PSTN), a financial network, any other suitable network that facilitates the exchange of information from one part of the network to another, or a combination thereof. In one or more embodiments, the network (110) is coupled to or overlaps with the Internet. In one or more embodiments of the invention, one or more of the modules and elements shown in FIG. 1 may be omitted, repeated, and/or substituted. Accordingly, embodiments of the invention should not be considered limited to the specific arrangements of modules shown in FIG. 1.

In one or more embodiments of the invention, the user (101) is a business entity engaged in the trade of goods, services, or both to customers (e.g., customers (102a)), such as an individual consumer or business consumer. In particular, an individual consumer is a person or group (e.g., family or other organization) that consumes goods and/or services. A business consumer is a business that consumes goods and/or services. In one or more embodiments of the invention, the business entity may be a sole proprietorship, partnership, company, non-profit organization, etc. For example, the business entity may have a storefront located in at least one physical location. Alternatively or additionally, the business entity may correspond to an Internet business that has an associated website (referred to as an online store). In one or more embodiments, the goods and/or services sold by the business entity correspond to the merchandise sold by the business entity to the customers (e.g., customer (102a)).

In one or more embodiments of the invention, the user (101) purchases goods and/or services that are modified or enhanced by the corresponding business entity for reselling to the customers (e.g., customer (102a)). For example, the business entity may purchase the goods and/or services from vendors (e.g., vendor (102b)), such as a manufacturer, a distributor, or other suppliers. In one or more embodiments, the goods and/or services purchased by the business entity correspond to the merchandise purchased by the business entity from the vendors (e.g., vendor (102b)). Further, as used herein, the business entity is deemed to perform an action when the action is performed on behalf of the business entity. For example, an owner, agent, or officer may act on behalf of the business entity to perform an action. In one or more embodiments, the user (101) may include a computing device configured with computing, data storage, and network communication functionalities. For example, the user (101) may use the computing device (not shown) to access the FMA (140) to manage business financial information, such as information related to selling goods and/or services to the customers (e.g., customer (102a)) and/or purchasing goods and/or services from the vendors (e.g., vendor (102b)).

In one or more embodiments of the invention, the user (101) includes functionality to perform one or more financial transactions with one or more customers and one or more vendors. In one or more embodiments, a financial transaction is a payment associated with the aforementioned trade of goods and/or services. Such financial transaction may be performed to settle a sale of a merchandise item, a purchase of a merchandise item, a return of a merchandise item, a down payment on a merchandise item, or any other related fees. In one or more embodiments, the financial transactions may further include payroll payments to employees, contractors, or other human resources of the business entity, tax and/or licensing payments to regulatory agencies/organizations, capital spending with respect to equipment/machineries, short term and/or long term loan payments, etc.

In one or more embodiments of the invention, the FMA (140) is a set of software solutions designed to manage the aforementioned trades, other financial activities, and associated financial transactions of the user (101). In one or more embodiments of the invention, the FMA (140) may be an accounting software, a business tax preparation application, or any other types of business financial management application. In one or more embodiments, the FMA (140) is provided by an application service provider, such as a software as a service (SaaS). For example, the FMA (140) may be operated by the application service provider (ASP) and accessed by the user (101) on a subscription basis.

In one or more embodiments, the repository (150) may include a disk drive storage device, a semiconductor storage device, a database management system, other suitable computer data storage devices, or combinations thereof. In one or more embodiments, content stored in the repository (150) may be a data file, a linked list, a data sequence, a database, a graphical representation, or any other suitable data structure. In one or more embodiments of the invention, the repository (150) includes functionality to store data for the FMA (140). The data stored in the repository (150) includes financial documents (e.g., financial document A (151a), financial document B (151b), etc.) and an activity feed (152) that are generated and used by the FMA (140). Each of these components is described below.

In one or more embodiments of the invention, a financial document (e.g., financial document A (151a), financial document B (151b)) is a document generated and/or maintained by the FMA (140) to perform a task of the FMA (140). For example, the task may be one of initiating, tracking, settling, reporting, or otherwise managing the aforementioned trades, other financial activities, and associated financial transactions of the user (101). In particular, the user (101) accesses one or more financial documents (e.g., financial document A (151a), financial document B (151b)) while using the FMA (140) to perform the task. For example, performing the task of submitting a purchase order to initiate a trade with the vendor (102b) may include the user (101) accessing a customer list to retrieve information of the vendor (102b) and accessing a quotation from the vendor (102b) to review the financial terms. In addition, the user (101) may access the purchase order itself for review, edit, and approval before submitting to the vendor (102b). In this example, the financial documents (e.g., financial document A (151a), financial document B (151b)) include the customer list, the quotation, and the purchase order.

In one or more embodiments of the invention, a financial document (e.g., financial document A (151a), financial document B (151b)) may be created, edited, or deleted as a result of access by the user (101). As used herein, each creation, editing, or deletion of any financial document is referred to as an activity. Accordingly, the type of each activity may be one of creation, editing, and deletion. In one or more embodiments, all activities (e.g., activity A (152a), activity B (152b)) performed during a pre-determined time period (e.g., an hour, a day, a week, a month, etc.) is logged in the activity feed (152), which is a data structure to store recorded information regarding each activity. In addition, the activity feed (152) includes metadata (153) describing characteristics of performing the activities during the pre-determined time period. For example, each of the activity A (152a) and activity B (152b) may correspond to one of creating, editing, or deleting the financial document A (151a). In another example, the activity A (152a) may correspond to one of creating, editing, or deleting the financial document A (151a), while the activity B (152b) may correspond to one of creating, editing, or deleting the financial document B (151b).

In one or more embodiments of the invention, the metadata (153) identifies the type of each activity in the activity list and includes a characteristic of performing a single activity and/or a characteristic of performing multiple related activities. For example, the metadata (153) may identify the activity A (152a) as an edit and include a link between a previous version and an updated version of the financial document A (151a) that was edited by the activity A (152a). In another example, the metadata (153) may identify the activity B (152b) as a deletion and include a link to the financial document B (151b) that was deleted by the activity B (152b). In yet another example, the metadata (153) may include a parent-child relationship between the activity A (152a) and the activity B (152b). In one or more embodiments, if the activity A (152) is required for the activity B (152b) to be performed, the activity A (152) is referred to as a parent of the activity B (152b), and the activity B (152b) is referred to as a child of the activity A (152a). For example, the activity A (152a) may be editing a customer list (i.e., financial document A (151a)) to add a customer, which is a parent to the activity B (152b) of creating an invoice (i.e., financial document B (151b)) to the customer based on the customer list. In one or more embodiments, multiple parent-child relationships are arranged as a hierarchical tree in the metadata (153). In one or more embodiments, the pre-determined time period of logging the activities may be initiated and/or terminated periodically, automatically, based on an event, or in response to a user input.

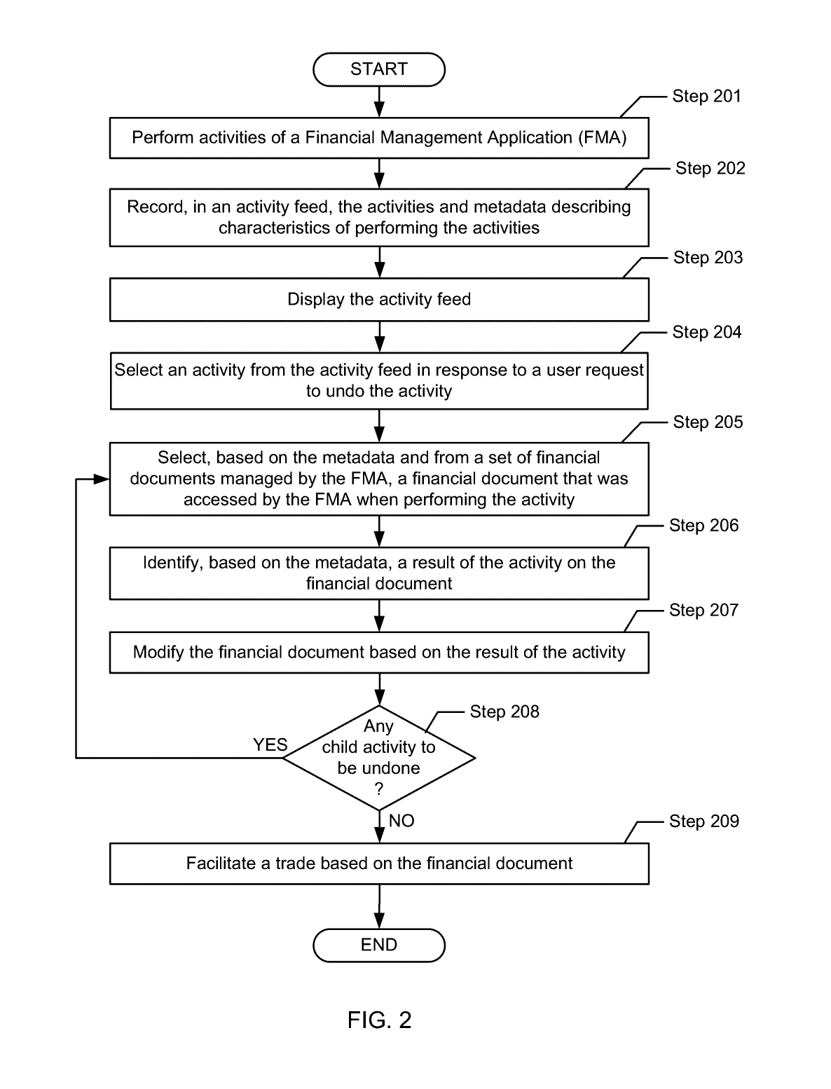

In one or more embodiments of the invention, the activity engine (142) is configured to perform activities of the FMA (140) for initiating, tracking, settling, reporting, or otherwise managing the trades, other financial activities, and associated financial transactions of the user (101). In one or more embodiments of the invention, the undo engine (143) is configured to record, in the activity feed (153), the aforementioned activities (e.g., activity A (152a), activity B (152b), etc.) and the metadata (153). In one or more embodiments of the invention, the user interface module (141) is configured to display the activity feed (152). Further, the undo engine (143) and the user interface module (141) are configured to collectively perform the undo function using the method described in reference to FIG. 2 below.

FIG. 2 shows a flowchart in accordance with one or more embodiments of the invention. In one or more embodiments of the invention, the method of FIG. 2 may be practiced using the system (100) described in reference to FIG. 1 above. In one or more embodiments of the invention, one or more of the steps shown in FIG. 2 may be omitted, repeated, and/or performed in a different order than that shown in FIG. 2. Accordingly, the specific arrangement of steps shown in FIG. 2 should not be construed as limiting the scope of the invention.

Initially, in Step 201, activities associated with financial documents are performed by a user using a financial management application (FMA). In one or more embodiments of the invention, one or more activities are performed to complete a task of the FMA, such as for initiating, tracking, settling, reporting, or otherwise managing trades, other financial activities, and associated financial transactions of the user with a trading partner.

In Step 202, the activities and metadata describing characteristics of performing the activities are recorded in an activity feed.

In Step 203, the activity feed is displayed to the user without displaying any content of the associated financial documents. In one or more embodiments of the invention, the activity feed is displayed adjacent to a user interface window (referred to as a task window) used to perform a task of the FMA. In particular, the activity feed display is selectively enabled or disabled based on a user command. In one or more embodiments, activities recorded in the activity feed are displayed according to a chronological order. Each activity is displayed to identify the associated financial document and the action (i.e., creation, editing, or deletion) performed on the financial document. For example, the activity may be represented in the activity feed display by a file name or a description of the financial document. The displayed activity may be highlighted based on the type of the action and annotated with a time stamp of the activity and/or metadata associated with the activity.

In Step 204, a user request to undo an activity is received in response to displaying the activity feed. In one or more embodiments of the invention, the user selects the activity from the displayed activity feed for requesting to undo the activity.

In Step 205, based on the metadata and from all financial documents represented in the activity feed display, a financial document is selected. Specifically, the selected financial document was accessed by the FMA when performing the activity that the user requests to undo.

In Step 206, a result of the activity on the financial document is identified based on the metadata. In one or more embodiments of the invention, the result is identified based on the activity type indicated by the metadata. For example, the result is one of the financial document being created, edited, or deleted.

In Step 207, the financial document is modified based on the result of the activity. In one or more embodiments of the invention, the financial document is deleted, rolled back, or recreated to remove the result. For example, the financial document may be rolled back to remove an edit applied to the financial document during the activity. In one or more embodiments, rolling back the financial document includes replacing, without user intervention and without opening the financial document, an updated version of the financial document by a previous version of the financial document.

In Step 208, based on the metadata, a determination is made as to whether there is any child activity to the activity processed in Step 205 through Step 207. In other words, it is determined whether the activity associated with the financial document modified in Step 207 has a child based on any parent-child relationship in the metadata. If the determination is positive, i.e., the activity is a parent to a child activity, the method returns to another iteration of Step 205 through Step 207 where the child activity is processed. Specifically, the result of the child activity is undone in another iteration of Step 205 through Step 207.

In one or more embodiments of the invention, undoing the child activity is dependent on a type of edit performed by the parent activity. In an example scenario, the parent activity includes editing the financial document from a previous version to an updated version, while the child activity includes generating another financial document based on the updated version of the financial document. In this scenario, processing the child activity in Step 207 may include rolling back the result of the parent activity by re-generating the another financial document based on the previous version of the financial document. For example, if the parent activity edits a profile of a vendor in a vendor list to generate the updated version of the vendor list, and the child activity generates a purchase order to the vendor based on the profile, then rolling back the result of parent activity includes re-generating the purchase order base on the profile in the previous version of the vendor list.

Alternatively, if the previous version of the financial documents precludes re-generating the another financial document, processing the child activity in Step 207 may delete the another financial document that was generated based on the previous version of the financial document and generates an alert that the another financial document is deleted. For example, if the parent activity edits a vendor list to add a profile of a vendor to the updated version of the vendor list, and the child activity generates a purchase order to the vendor based on the profile, then rolling back the result of parent activity includes deleting the purchase order since the purchase order to the vendor can not be generated based on any profile in the previous version of the vendor list.

In Step 209, a trade between the user and a trading partner of the user is facilitated based on one or more financial documents that are modified through the iteration(s) from Step 205 through Step 207. For example, the purchase order modified in the aforementioned child activity is sent to the vendor to initiate the trade.

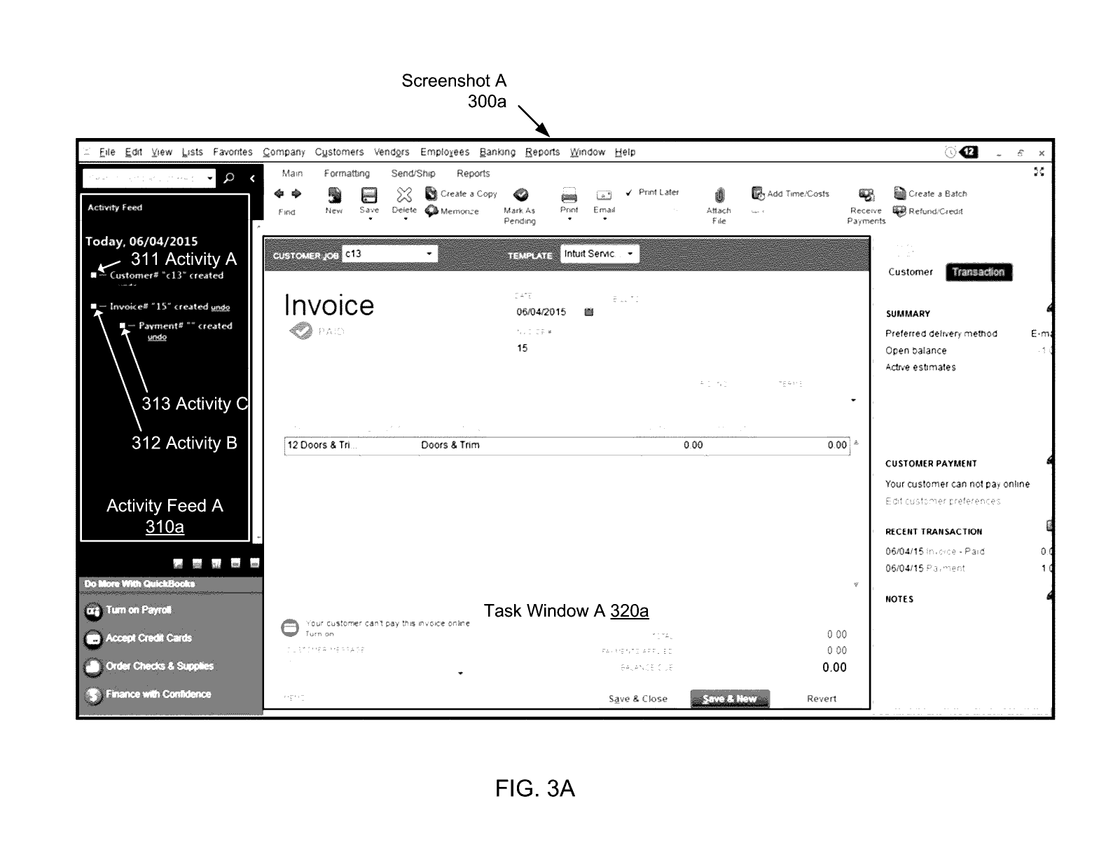

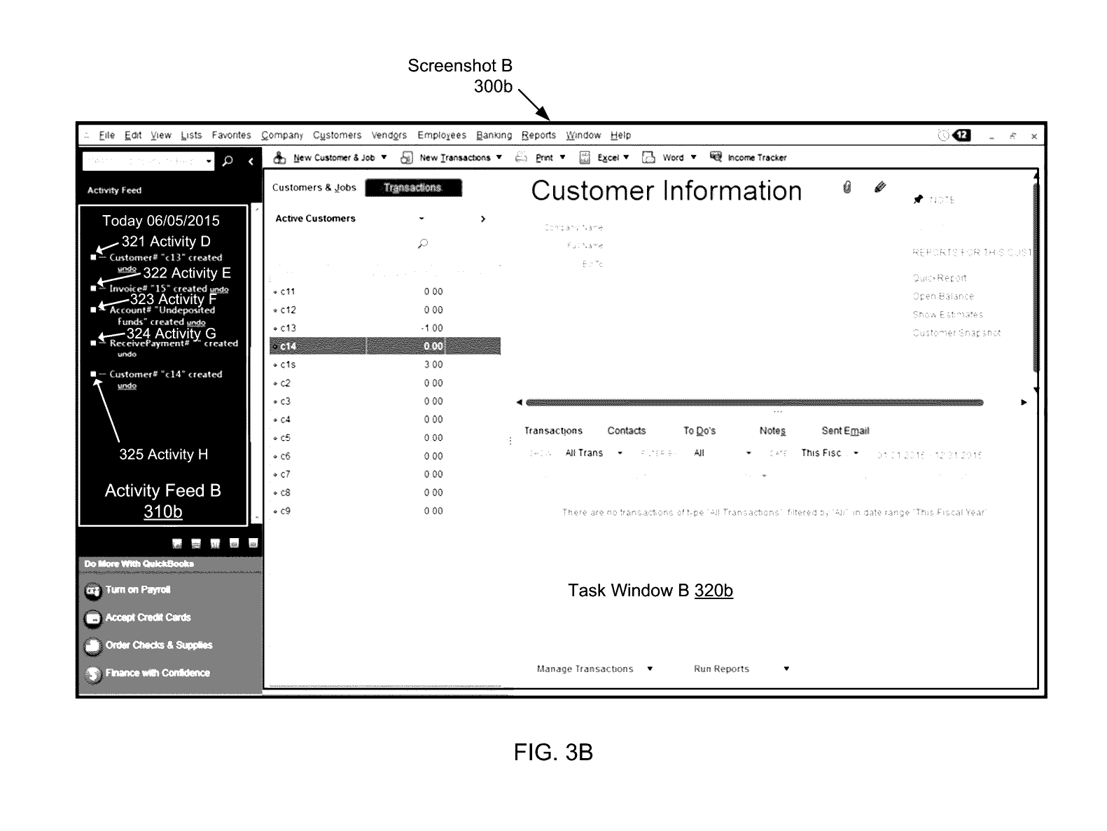

FIGS. 3A and 3B show an example in accordance with one or more embodiments of the invention. The example may be practiced based on the system (100) and the method flow chart depicted in FIG. 1 and FIG. 2, respectively.

FIG. 3A shows a screenshot A (300a) of the FMA. Specifically, the screenshot A (300a) includes the activity feed A (310a) and the task window A (320a). In particular, the activity feed A (310a) shows logged activities during the current day of Jun. 4, 2015. Each activity is represented as a square icon and annotated with a description of the financial document accessed by the activity. As shown in FIG. 3A, the activity A (311), activity B (312), and activity C (313) are arranged hierarchically to represent parent-child relationships based on indentation. In addition, the activities are arranged according to a chronological order where the activity C (313) is the most recent activity. In particular, the activity B (312) is a parent of the child activity C (313) because the payment record created by the activity C (313) requires the corresponding invoice record to be created first by the activity B (312). Further, the task window A (320a) shows the user activity of generating the invoice record, which is logged in the activity feed A (310a) as the activity B (312).

FIG. 3B shows a screenshot B (300b) of the FMA. Specifically, the screenshot B (300b) includes the activity feed B (310b) and the task window B (320b). In particular, the activity feed B (310b) shows logged activities during the current day of Jun. 5, 2015 in a flat format without explicitly representing any hierarchical parent-child relationship. In addition, the activity D (321), activity E (322), activity F (323), activity G (324), and activity H (325) are arranged according to a chronological order where the activity D (321) is the first activity during the day and the activity H (325) is the most recent activity. In particular, the activity E (322) is a parent of the child activity G (342). As shown in FIG. 2B, the user may select the activity E (322) to be undone without needing to manually undo any more recent activity. In response to the selection, the activity E (322) and the child activity G (342) will be undone by deleting the invoice and payment record that were generated by the activity E (322) and the child activity G (342), respectively. Accordingly, the activity D (321), activity F (323), and activity H (325) remain in the activity feed B (310b) with an additional activity added (not shown) in the activity feed B (310b) to log the new activity of undoing the activity F (322).

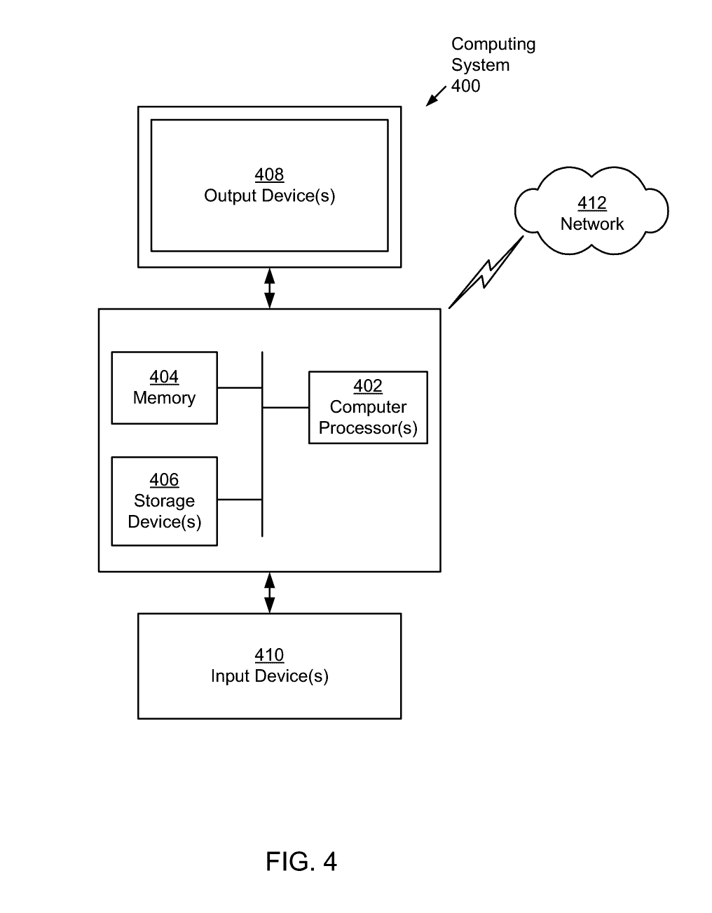

Embodiments of the invention may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device. The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (400) may be located at a remote location and connected to the other elements over a network (412). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for managing a plurality of financial documents using a financial management application (FMA), comprising:
performing a plurality of activities of the FMA;
recording, in an activity feed, the plurality of activities and metadata describing characteristics of performing the plurality of activities;
selecting, in response to a user request to undo a first activity of the plurality of activities, the first activity from the activity feed;
selecting, based on the metadata and from the plurality of financial documents, a first financial document that was accessed by the FMA when performing the first activity;
identifying, based on the metadata, a first result of the first activity on the first financial document; and
modifying the first financial document to remove the first result of the first activity.

2. The method of claim 1, further comprising:
displaying the activity feed without displaying any content of the first financial document; and
receiving, in response to the displaying, the user request to undo the first activity,
wherein the first activity comprises at least one selected from a group consisting of creating, editing, and deleting the first financial document.

3. The method of claim 1,
wherein performing the first activity comprises editing a previous version of the first financial document into an updated version of the first financial document, wherein the first result comprises an edit of the first financial document,
wherein modifying the first financial document comprises:
replacing, without user intervention and without opening the first financial document, the updated version by the previous version of the financial document to remove the edit, and
wherein the metadata comprises a link between the updated version and the previous version.

4. The method of claim 1, further comprising:
selecting, from the activity feed and further in response to the user request to undo the first activity, a second activity of the plurality of activities, wherein the second activity is selected based on a parent-child relationship with the first activity as specified by the metadata;
selecting, based on the metadata and from the plurality of financial documents, a second financial document that was accessed by the FMA when performing the second activity;
identifying, based on the metadata, a second result of the second activity on the second financial document; and
modifying the second financial document to remove the second result of the second activity.

5. The method of claim 4, wherein performing the second activity comprises:
generating the second financial document based on the updated version of the first financial document.

6. The method of claim 4, wherein modifying the second financial document comprises:
re-generating the second financial document based on the previous version of the first financial document.

7. The method of claim 4, wherein modifying the second financial document comprises:
deleting the second financial document; and
generating an alert that the second financial document is deleted.

8. A system comprising:
a computer processor;
memory storing instructions of a financial management application (FMA) that is executable by the computer processor for managing a plurality of financial documents, the instructions comprising:
an activity engine configured to perform a plurality of activities of the FMA, and
an undo engine configured to:
record, in an activity feed, the plurality of activities and metadata describing characteristics of performing the plurality of activities,
select, in response to a user request to undo a first activity of the plurality of activities, the first activity from the activity feed,
select, based on the metadata and from the plurality of financial documents, a first financial document that was accessed by the FMA when performing the first activity,
identify, based on the metadata, a first result of the first activity on the first financial document, and
modify the first financial document to remove the first result of the first activity; and
a repository configured to store the activity feed and the first financial document.

9. The system of claim 8, the instructions further comprising a user interface module configured to:
display the activity feed without displaying any content of the first financial document; and
receive, in response to the displaying, the user request to undo the first activity,
wherein the first activity comprises at least one selected from a group consisting of creating, editing, and deleting the first financial document.

10. The system of claim 8,
wherein performing the first activity comprises:
opening, in response to a first user input, the first financial document;
applying, in response to a second user input, an update to the first financial document, wherein the first result comprises the update; and
closing, in response to a third user input, the first financial document into an updated version comprising the update,
wherein modifying the first financial document comprises:
replacing, without user intervention and without opening the first financial document, the updated version by a previous version of the financial document to remove the first result, and
wherein the metadata comprises a link between the updated version and the previous version.

11. The system of claim 8, the undo engine further configured to:
select, from the activity feed and further in response to the user request to undo the first activity, a second activity of the plurality of activities, wherein the second activity is selected based on a parent-child relationship with the first activity as specified by the metadata;
select, based on the metadata and from the plurality of financial documents, a second financial document that was accessed by the FMA when performing the second activity;
identify, based on the metadata, a second result of the second activity on the second financial document; and
modify the second financial document to remove the second result of the second activity.

12. The system of claim 11, wherein performing the second activity comprises:
generating the second financial document based on the updated version of the first financial document.

13. The system of claim 11, wherein modifying the second financial document comprises:
re-generating the second financial document based on the previous version of the first financial document.

14. The system of claim 11, wherein modifying the second financial document comprises:
deleting the second financial document; and
generating an alert that the second financial document is deleted.

15. A non-transitory computer readable medium storing instructions for managing a plurality of financial documents using a financial management application (FMA), the instructions, when executed by a computer processor, comprising functionality for:
performing a plurality of activities of the FMA;
recording, in an activity feed, the plurality of activities and metadata describing characteristics of performing the plurality of activities;
selecting, in response to a user request to undo a first activity of the plurality of activities, the first activity from the activity feed;
selecting, based on the metadata and from the plurality of financial documents, a first financial document that was accessed by the FMA when performing the first activity;
identifying, based on the metadata, a first result of the first activity on the first financial document; and
modifying the first financial document to remove the first result of the first activity.

16. The non-transitory computer readable medium of claim 15, the instructions, when executed by the computer processor, further comprising functionality for:
displaying the activity feed without displaying any content of the first financial document; and
receiving, in response to the displaying, the user request to undo the first activity,
wherein the first activity comprises at least one selected from a group consisting of creating, editing, and deleting the first financial document.

17. The non-transitory computer readable medium of claim 15,
wherein performing the first activity comprises editing a previous version of the first financial document into an updated version of the first financial document, wherein the first result comprises an edit of the first financial document,
wherein modifying the first financial document comprises:
replacing, without user intervention and without opening the first financial document, the updated version by the previous version of the financial document to remove the edit, and
wherein the metadata comprises a link between the updated version and the previous version.

18. The non-transitory computer readable medium of claim 15, the instructions, when executed by the computer processor, further comprising functionality for:
selecting, from the activity feed and further in response to the user request to undo the first activity, a second activity of the plurality of activities, wherein the second activity is selected based on a parent-child relationship with the first activity as specified by the metadata;
selecting, based on the metadata and from the plurality of financial documents, a second financial document that was accessed by the FMA when performing the second activity;
identifying, based on the metadata, a second result of the second activity on the second financial document; and
modifying the second financial document to remove the second result of the second activity.

19. The non-transitory computer readable medium of claim 18, wherein performing the second activity comprises:
generating the second financial document based on the updated version of the first financial document.

20. The non-transitory computer readable medium of claim 18, wherein modifying the second financial document comprises:
re-generating the second financial document based on the previous version of the first financial document.
